(19) United States
(12) Patent Application Publication
(10) Pub. No.: US 2024/0037105 A1
(43) Pub. Date: Feb. 1, 2024

(54) Predicting Record Hierarchies and Record Groups for Records Bulk Loaded into a Data Management System

(71) Applicant: International Business Machines Corporation, Armonk, NY (US)

(72) Inventors: Abhishek Seth, Deoband (IN); Megha Oulkar, Bengaluru (IN); Matheen Ahmed Pasha, Bengaluru (IN); Shettigar Parkala Srinivas, Bengaluru (IN)

(21) Appl. No.: 17/815,397

(22) Filed: Jul. 27, 2022

(51) Int. Cl. G06F 16/2457; G06F 16/28

(52) U.S. Cl. CPC G06F 16/24575; G06F 16/282

(57) ABSTRACT

Managing record hierarchies and record groups in a data management system is provided. A root record node is identified for a record hierarchy. A probabilistic search of a graph of the record hierarchy is performed to identify record nodes related to the root record node based on record relationships data. Identified record nodes related to the root record node are positioned as a level under the root record node in the record hierarchy. Any record nodes that are not related to the root record node but match a definition of the record hierarchy are identified. It is determined whether a set of record nodes unrelated to the root record node was identified. In response to determining that a set of record nodes unrelated to the root record node was not identified, it is determined that records matching the definition of the record hierarchy are positioned in the record hierarchy.

### BACKGROUND

### 1. Field

The disclosure relates generally to data management and more specifically to predicting record hierarchies and record groups for records bulk loaded into a data management system.

### 2. Description of the Related Art

Data management is the practice of collecting, storing, and utilizing data securely, efficiently, and cost-effectively. Data management is concerned with the end-to-end lifecycle of data, from creation to retirement, and the controlled progression of data to and from each stage within its lifecycle. The goal of data management is to optimize the use of data within the bounds of policy and regulation so that entities, such as, for example, enterprises, businesses, companies, organizations, institutions, agencies, or the like, can make decisions and take actions to maximize benefit to those entities.

### SUMMARY

According to one illustrative embodiment, a computer-implemented method for managing record hierarchies and record groups in a data management system is provided. A computer identifies a root record node that is defined by a user for a selected record hierarchy. The computer performs a probabilistic search of a graph of the selected record hierarchy to identify record nodes related to the root record node defined by the user based on record relationships data bulk loaded into the data management system. The computer positions identified record nodes related to the root record node as a next level under the root record node in the selected record hierarchy. The computer identifies any record nodes that are not related to the root record node defined by the user but match a definition of the selected record hierarchy. The computer determines whether a set of record nodes unrelated to the root record node defined by the user was identified. In response to the computer determining that a set of record nodes unrelated to the root record node defined by the user was not identified, the computer determines that records matching the definition of the selected record hierarchy are positioned in the selected record hierarchy. According to other illustrative embodiments, a computer system and computer program product for managing record hierarchies and record groups in a data management system are provided.

### BRIEF DESCRIPTION OF THE DRAWINGS

FIG. 1 is a pictorial representation of a network of data processing systems in which illustrative embodiments may be implemented;

FIG. 2 is a diagram of a data processing system in which illustrative embodiments may be implemented;

FIGS. 3A-3C are a flowchart illustrating a process for placing records in record hierarchies defined in a data management system is shown in accordance with an illustrative embodiment; and

FIGS. 4A-4C are a flowchart illustrating a process for grouping records in record groups defined in a data management system is shown in accordance with an illustrative embodiment.

### DETAILED DESCRIPTION

The present invention may be a system, a method, and/or a computer program product at any possible technical detail level of integration. The computer program product may include a computer-readable storage medium (or media) having computer-readable program instructions thereon for causing a processor to carry out aspects of the present invention.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

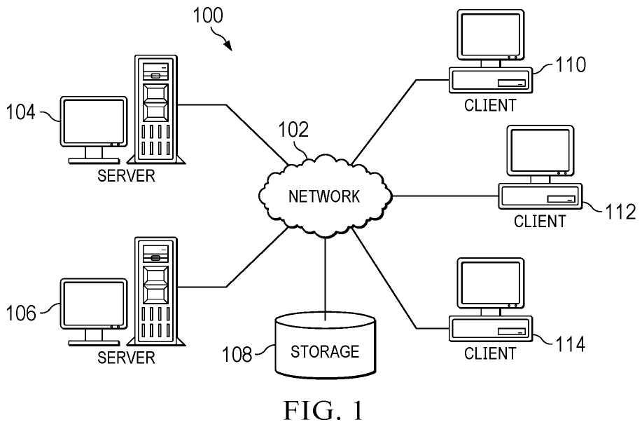

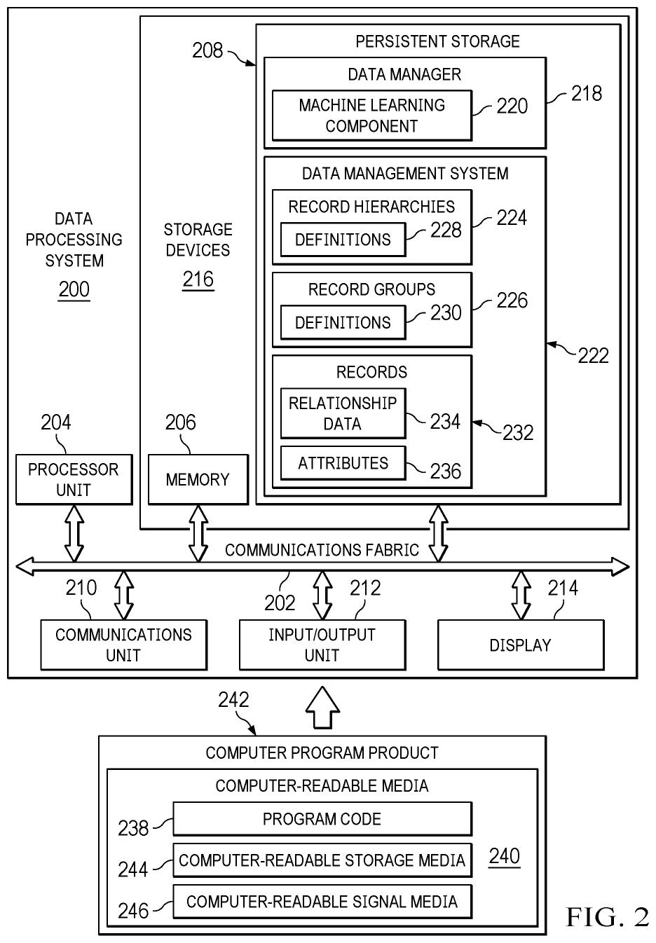

With reference now to the figures, and in particular, with reference to FIG. 1 and FIG. 2, diagrams of data processing environments are provided in which illustrative embodiments may be implemented. It should be appreciated that FIG. 1 and FIG. 2 are only meant as examples and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers, data processing systems, and other devices in which the illustrative embodiments may be implemented. Network data processing system 100 contains network 102, which is the medium used to provide communications links between the computers, data processing systems, and other devices connected together within network data processing system 100. Network 102 may include connections, such as, for example, wire communication links, wireless communication links, fiber optic cables, and the like.

In the depicted example, server 104 and server 106 connect to network 102, along with storage 108. Server 104 and server 106 may be, for example, server computers with high-speed connections to network 102. Also, server 104 and server 106 may each represent a cluster of servers in one or more data centers. Alternatively, server 104 and server 106 may each represent multiple computing nodes in one or more cloud environments.

In addition, server 104 and server 106 provide a set of data management services for subscribing customers, such as, for example, enterprises, companies, businesses, organizations, institutions, agencies, and the like. Each of server 104 and server 106 includes a data management system for managing a plurality of data records (e.g., thousands, millions, billions, or the like) that are bulk loaded and live streamed into the data management system from a plurality of different record sources corresponding to the subscribing customers. Server 104 and server 106 provide the data management services by automatically predicting and assigning each record of the plurality of records to a defined record hierarchy and record group in real time when the plurality of records is onboarded to the data management system in bulk. It should be noted that each of server 104 and server 106 can assign records to record hierarchies and record groups in parallel.

Client 110, client 112, and client 114 also connect to network 102. Clients 110, 112, and 114 correspond to subscribing customers and are client devices of server 104 and server 106. In this example, clients 110, 112, and 114 are shown as desktop or personal computers with wire communication links to network 102. However, it should be noted that clients 110, 112, and 114 are examples only and may represent other types of data processing systems, such as, for example, network computers, laptop computers, handheld computers, smart phones, smart televisions, and the like, with wire or wireless communication links to network 102. Users of clients 110, 112, and 114 may utilize clients 110, 112, and 114 to access and utilize the data management services provided by server 104 and server 106.

Storage 108 is a network storage device capable of storing any type of customer records in a structured format or an unstructured format. In addition, storage 108 may represent a plurality of network storage devices. For example, storage 108 may represent a plurality of different record sources storing a plurality of different types of records corresponding to a plurality of different subscribing customers. Further, storage 108 may store other types of data, such as authentication or credential data that may include usernames, passwords, and the like associated with, for example, data stewards, system administrators, and client device users.

In addition, it should be noted that network data processing system 100 may include any number of additional servers, clients, storage devices, and other devices not shown. Program code located in network data processing system 100 may be stored on a computer-readable storage medium or a set of computer-readable storage media and downloaded to a computer or other data processing device for use. For example, program code may be stored on a computer-readable storage medium on server 104 and downloaded to client 110 over network 102 for use on client 110.

In the depicted example, network data processing system 100 may be implemented as a number of different types of communication networks, such as, for example, an internet, an intranet, a wide area network, a local area network, a telecommunications network, or any combination thereof. FIG. 1 is intended as an example only, and not as an architectural limitation for the different illustrative embodiments.

As used herein, when used with reference to items, “a number of” means one or more of the items. For example, “a number of different types of communication networks” is one or more different types of communication networks. Similarly, “a set of,” when used with reference to items, means one or more of the items.

Further, the term “at least one of,” when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item B. This example may also include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

With reference now to FIG. 2, a diagram of a data processing system is depicted in accordance with an illustrative embodiment. Data processing system 200 is an example of a computer, such as server 104 in FIG. 1, in which computer-readable program code or instructions implementing the data management processes of illustrative embodiments may be located. In this example, data processing system 200 includes communications fabric 202, which provides communications between processor unit 204, memory 206, persistent storage 208, communications unit 210, input/output (I/O) unit 212, and display 214.

Processor unit 204 serves to execute instructions for software applications and programs that may be loaded into memory 206. Processor unit 204 may be a set of one or more hardware processor devices or may be a multi-core processor, depending on the particular implementation.

Memory 206 and persistent storage 208 are examples of storage devices 216. As used herein, a computer-readable storage device or a computer-readable storage medium is any piece of hardware that is capable of storing information, such as, for example, without limitation, data, computer-readable program code in functional form, and/or other suitable information either on a transient basis or a persistent basis. Further, a computer-readable storage device or a computer-readable storage medium excludes a propagation medium, such as transitory signals. Furthermore, a computer-readable storage device or a computer-readable storage medium may represent a set of computer-readable storage devices or a set of computer-readable storage media. Memory 206, in these examples, may be, for example, a random-access memory, or any other suitable volatile or non-volatile storage device, such as a flash memory. Persistent storage 208 may take various forms, depending on the particular implementation. For example, persistent storage 208 may contain one or more devices. For example, persistent storage 208 may be a disk drive, a solid-state drive, a rewritable optical disk, a rewritable magnetic tape, or some combination of the above. The media used by persistent storage 208 may be removable. For example, a removable hard drive may be used for persistent storage 208.

In this example, persistent storage 208 stores data manager 218. However, it should be noted that even though data manager 218 is illustrated as residing in persistent storage 208, in an alternative illustrative embodiment data manager 218 may be a separate component of data processing system 200. For example, data manager 218 may be a hardware component coupled to communication fabric 202 or a combination of hardware and software components. In another alternative illustrative embodiment, a first set of components of data manager 218 may be located in data processing system 200 and a second set of components of data manager 218 may be located in a second data processing system, such as, for example, server 106 in FIG. 1.

Data manager 218 controls the process of automatically managing, in real time, the placement of bulk loaded and live streamed records 232 into record hierarchies 224 and record groups 226 within data management system 222 using machine learning component 220. In this example, data manager 218 includes machine learning component 220. However, in alternative illustrative embodiments, machine learning component 220 is a stand-alone component or separate from data manager 218.

Machine learning component 220 can learn without being explicitly programmed to do so. Machine learning component 220 can learn based on training data input into machine learning component 220. Machine learning component 220 can learn using various types of machine learning algorithms. The various types of machine learning algorithms include at least one of supervised learning, semi-supervised learning, unsupervised learning, feature learning, sparse dictionary learning, anomaly detection, association rules, or other types of learning algorithms. Examples of machine learning models include an artificial neural network, a decision tree, a support vector machine, a Bayesian network, and other types of models. Machine learning component 220 is trained using historical data regarding previous placement of customer records within particular record hierarchies and record groups within data management system 222.

Data management system 222 includes record hierarchies 224 and record groups 226. A user, such as, for example, a data steward, defines each respective record hierarchy of record hierarchies 224 and each respective record group of record groups 226. Record hierarchies 224 represent a plurality of different record hierarchies (e.g., hundreds, thousands, or the like) within data management system 222. Data manager 218 may represent record hierarchies 224 as graphs comprised of a plurality of different levels, each level containing a set of record nodes and edges connecting related record nodes. Record groups 226 represent a plurality of different record groups (e.g., hundreds, thousands, or the like) within data management system 222. Each record group contains a plurality of contextually related records. The context of a given record group corresponds to a definition of that particular record group.

Record hierarchies 224 include definitions 228. A given definition of definitions 228 corresponds to a particular record hierarchy in record hierarchies 224. In other words, each respective record hierarchy has a record hierarchy definition. The definition of a given record hierarchy describes or delineates the type of records that comprise that particular record hierarchy. Similarly, record groups 226 include definitions 230. A given definition of definitions 230 corresponds to a particular record group in record groups 226. In other words, each respective record group has a record group definition. The definition of a given record group describes or delineates the type of records that comprise that particular record group.

Records 232 represent a plurality of records (e.g., thousands, millions, billions, or the like) bulk loaded into data management system 222 via a network, such as, for example, network 102 in FIG. 1, from a set of record sources, such as, for example, storage 108 in FIG. 1, corresponding to a subscribing customer. Records 232 may also include records that are live streaming into data management system 222 from the set of record sources corresponding to the subscribing customer after initial bulk load of records 232.

Relationship data 234 corresponds to records 232. Relationship data 234 describes relationships between different records within records 232. The relationships between different records within records 232 can be based on attributes 236. Attributes 236 are the features, characteristics, properties, traits, and the like of each respective record in records 232. The record source corresponding to the subscribing customer associated with records 232 can provide relationship data 234 to data management system 222. Alternatively, data management system 222 can generate relationship data 234 based on attributes 236. Data manager 218 utilizes relationship data 234 to perform probabilistic searches of record hierarchy graphs to identify related record nodes for a particular record hierarchy. Data manager 218 also utilizes relationship data 234 to perform probabilistic searches of existing records in data management system 222 to identify contextually relevant candidate records for a particular record group.

As a result, data processing system 200 operates as a special purpose computer system in which data manager 218 in data processing system 200 enables automatic management of record hierarchies and record groups defined in the data management system in real time using machine learning. In particular, data manager 218 transforms data processing system 200 into a special purpose computer system as compared to currently available general computer systems that do not have data manager 218.

Communications unit 210, in this example, provides for communication with other computers, data processing systems, and devices via a network, such as network 102 in FIG. 1. Communications unit 210 may provide communications through the use of both physical and wireless communications links. The physical communications link may utilize, for example, a wire, cable, universal serial bus, or any other physical technology to establish a physical communications link for data processing system 200. The wireless communications link may utilize, for example, shortwave, high frequency, ultrahigh frequency, microwave, wireless fidelity, Bluetooth® technology, global system for mobile communications, code division multiple access, second-generation, third-generation, fourth-generation, fourth-generation Long Term Evolution, Long Term Evolution Advanced, fifth-generation, or any other wireless communication technology or standard to establish a wireless communications link for data processing system 200. Bluetooth is a registered trademark of Bluetooth Sig, Inc., Kirkland, Washington.

Input/output unit 212 allows for the input and output of data with other devices that may be connected to data processing system 200. For example, input/output unit 212 may provide a connection for user input through a keypad, a keyboard, a mouse, a microphone, and/or some other suitable input device. Display 214 provides a mechanism to display information to a user and may include touch screen capabilities to allow the user to make on-screen selections through user interfaces or input data, for example.

Instructions for the operating system, applications, and/or programs may be located in storage devices 216, which are in communication with processor unit 204 through communications fabric 202. In this illustrative example, the instructions are in a functional form on persistent storage 208. These instructions may be loaded into memory 206 for running by processor unit 204. The processes of the different embodiments may be performed by processor unit 204 using computer-implemented instructions, which may be located in a memory, such as memory 206. These program instructions are referred to as program code, computer usable program code, or computer-readable program code that may be read and run by a processor in processor unit 204. The program instructions, in the different embodiments, may be embodied on different physical computer-readable storage devices, such as memory 206 or persistent storage 208.

Program code 238 is located in a functional form on computer-readable media 240 that is selectively removable and may be loaded onto or transferred to data processing system 200 for running by processor unit 204. Program code 238 and computer-readable media 240 form computer program product 242. In one example, computer-readable media 240 may be computer-readable storage media 244 or computer-readable signal media 246.

In these illustrative examples, computer-readable storage media 244 is a physical or tangible storage device used to store program code 238 rather than a medium that propagates or transmits program code 238. Computer-readable storage media 244 may include, for example, an optical or magnetic disc that is inserted or placed into a drive or other device that is part of persistent storage 208 for transfer onto a storage device, such as a hard drive, that is part of persistent storage 208. Computer-readable storage media 244 also may take the form of a persistent storage, such as a hard drive, a thumb drive, or a flash memory that is connected to data processing system 200.

Alternatively, program code 238 may be transferred to data processing system 200 using computer-readable signal media 246. Computer-readable signal media 246 may be, for example, a propagated data signal containing program code 238. For example, computer-readable signal media 246 may be an electromagnetic signal, an optical signal, or any other suitable type of signal. These signals may be transmitted over communication links, such as wireless communication links, an optical fiber cable, a coaxial cable, a wire, or any other suitable type of communications link.

Further, as used herein, “computer-readable media 240” can be singular or plural. For example, program code 238 can be located in computer-readable media 240 in the form of a single storage device or system. In another example, program code 238 can be located in computer-readable media 240 that is distributed in multiple data processing systems. In other words, some instructions in program code 238 can be located in one data processing system while other instructions in program code 238 can be located in one or more other data processing systems. For example, a portion of program code 238 can be located in computer-readable media 240 in a server computer while another portion of program code 238 can be located in computer-readable media 240 located in a set of client computers.

The different components illustrated for data processing system 200 are not meant to provide architectural limitations to the manner in which different embodiments can be implemented. In some illustrative examples, one or more of the components may be incorporated in or otherwise form a portion of, another component. For example, memory 206, or portions thereof, may be incorporated in processor unit 204 in some illustrative examples. The different illustrative embodiments can be implemented in a data processing system including components in addition to or in place of those illustrated for data processing system 200. Other components shown in FIG. 2 can be varied from the illustrative examples shown. The different embodiments can be implemented using any hardware device or system capable of running program code 238.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system.

A typical data management system has definitions for multiple record hierarchies and record groups. In addition, a data management system can have millions of human and organization records that can be included in one or more record hierarchies and groups, which are defined by a user, such as, for example, a data steward, in the data management system. In a typical implementation of a data management system, the user manually assigns each individual person or organization record to a particular record hierarchy and group within the data management system, which is a huge undertaking in terms of time and effort by the user.

Current data management systems are incapable of determining which defined record hierarchy and group each newly added record should belong to. As a result, the user again has to manually assign the newly added records to one or more the defined record hierarchies and groups.

Data management systems have a multitude (e.g., tens, hundreds, or thousands) of defined record hierarchies and groups. As a result, it is impossible for the user to assign each record of a plurality of bulk loaded records (e.g., tens of millions, billions, or the like) to a defined record hierarchy and group in the data management system in real time. Consequently, it would be advantageous to have a data management system that is capable of automatically predicting and assigning each of the plurality of bulk loaded records to a defined record hierarchy and record group in real time when the plurality of records is onboarded to the data management system in bulk. This automatic record placement prediction and assignment by a data management system of illustrative embodiments will decrease user time and effort, as well as decrease human error.

In response to receiving a bulk load of records and corresponding record relationships data, illustrative embodiments initiate two bulk processes, which illustrative embodiments can perform in parallel within the data management system. It should be noted that illustrative embodiments can receive the bulk loaded records from a plurality of different record sources via a network. In addition, the corresponding record relationships data can be provided by the record sources or can be generated by the data management system based on attributes of the received records.

Record relationships data define relationships between record types. In other words, record relationships data create a link from one record type to a related record type. The link allows the record type to access the record fields and relationships defined on the related record type. The relationships can be one-to-one or one-to-many.

One of the bulk processes assigns records to hierarchies of records in the data management system based on the loaded records, the corresponding record relationships data, and a set of record hierarchy definitions in the data management system. The other bulk process assigns the records to groups of records in the data management system based on comparing contextually relevant attributes of the loaded records and relevant record relationships data corresponding to the loaded records. Contextually relevant attributes correspond to the definition of a selected record group. In other words, the context corresponds to a particular record group definition. Illustrative embodiments execute these two bulk processes in parallel to decrease processing time and increase computer performance.

During bulk load of a plurality of records (e.g., tens of thousands, tens of millions, tens of billions, or the like), the data management system of illustrative embodiments predicts in real time the record hierarchy and the record group that each respective newly loaded record should be included in. Further, it should be noted that illustrative embodiments can continue to receive live streaming of records after bulk load. Based on receiving record hierarchy and group predictions from the data management system, the user (e.g., data steward) can make an informed decision to add loaded records to one or more defined record hierarchies and record groups in the data management system. In addition, the data management system of illustrative embodiments can read the result of the record hierarchy and record group prediction for a particular record and automatically include that particular record (e.g., person or organization record) in a record hierarchy and record group in the data management system in real time.

Illustrative embodiments predict in real time which record hierarchies records belong to in the data management system in response to a multitude of records and corresponding record relationships data being bulk loaded into the data management system. After the records and corresponding record relationships data are bulk loaded into the data management system, illustrative embodiments select a record hierarchy of a set of record hierarchies defined by the user in the data management system. Illustrative embodiments filter out all records from the bulk loaded records that do not match the definition of the selected record hierarchy. Illustrative embodiments then identify a root record node, which is defined by the user, for the selected record hierarchy. Illustrative embodiments perform a probabilistic search of the graph of the selected record hierarchy to identify all record nodes related to the root record node defined by the user based on the record relationships data. A probabilistic search uses a statistical method to determine how closely records match a given set of search criteria. The probabilistic search generates match scores that consider the frequency of an occurrence of a given data value within a particular distribution.

Illustrative embodiments position the identified record nodes related to the root record node as a next sublevel under the root record node in the selected record hierarchy. In addition, illustrative embodiments identify any record nodes that are not related to the root record node but still match the definition of the selected record hierarchy. In response to illustrative embodiments identifying a set of unrelated record nodes to the root record node, illustrative embodiments select an unrelated record node of the set of unrelated record nodes. Illustrative embodiments position the selected unrelated record node as a new root record node in the graph of the selected record hierarchy. Illustrative embodiments then identify all record nodes related to the new root record node based on the loaded record relationships data and form a next sublevel under the new root record node in the selected record hierarchy. Illustrative embodiments repeat this process for each of the unrelated records nodes in the set of unrelated record nodes until illustrative embodiments determine that no more unrelated record nodes exist.

Illustrative embodiments then select another record hierarchy in the set of record hierarchies defined in the data management system and repeat the entire process above. In other words, illustrative embodiments perform this process for each respective record hierarchy of the set of record hierarchies defined in the data management system. Further, illustrative embodiments utilize machine learning (e.g., supervised, semi-supervised, unsupervised, or similar machine learning algorithm) to learn record placement patterns within record hierarchies based on the user's previous decisions to place records in predicted record hierarchies by illustrative embodiments so that illustrative embodiments can automatically determine which record hierarchy to place a particular record in and then automatically place that particular record in that particular record hierarchy.

Furthermore, illustrative embodiments predict in real time which record groups records belong to in the data management system in response to the multitude of records and corresponding record relationships data being bulk loaded into the data management system. In response to the records and corresponding record relationships data being bulk loaded into the data management system, illustrative embodiments select a record group of a set of record groups defined by the user in the data management system. Illustrative embodiments filter out all records from the bulk loaded records that do not match the definition of the selected record group. In other words, after illustrative embodiments filter out all records from the bulk loaded records that do not match the definition of the selected record group so that only a set of records that matches the definition of the selected record group remains.

Illustrative embodiments then select a record from the set of records that matches the definition of the selected record group. Illustrative embodiments also perform a probabilistic search of existing records in the data management system to identify a set of relevant candidate records based on the definition of the selected record group and the loaded record relationship data. Illustrative embodiments identify attributes of the selected record and attributes of each respective candidate record of the set of relevant candidate records. For example, illustrative embodiments may identify attributes, such as home address and phone number, for a record group defined as “prospectivecustomer” by the user. As another example, illustrative embodiments may identify attributes, such as member identifier and purchase history, for a record group defined as “valuedcustomer” by the user.

Illustrative embodiments then perform a comparison of the attributes of the selected record with the attributes of each respective candidate record of the set of relevant candidate records. Illustrative embodiments generate a comparison score between the selected record and each respective candidate record based on the comparison of the attributes of the selected record and the attributes of each respective candidate record of the set of relevant candidate records. In response to illustrative embodiments determining that the comparison score for the selected record and each respective candidate record is greater than or equal to a configurable minimum comparison score threshold level, illustrative embodiments determine that the selected record and each respective candidate record belong to the selected record group. In response to determining that the selected record and each respective candidate record belong to the selected record group, illustrative embodiments send a recommendation to the user that the selected record and each respective candidate record should be assigned to the selected record group.

Illustrative embodiments perform the record grouping process above for each respective record group of the set of record groups defined in the data management system. Further, illustrative embodiments utilize machine learning to learn record placement patterns within record groups based on the user's previous decisions to place records in recommended record groups by illustrative embodiments so that illustrative embodiments can automatically determine which record group to place a particular record in and then automatically place that particular record in that particular record group.

Thus, illustrative embodiments provide one or more technical solutions that overcome a technical problem with placing a multitude of bulk loaded records into record hierarchies and record groups within a data management system in real time. As a result, these one or more technical solutions provide a technical effect and practical application in the field of data management.

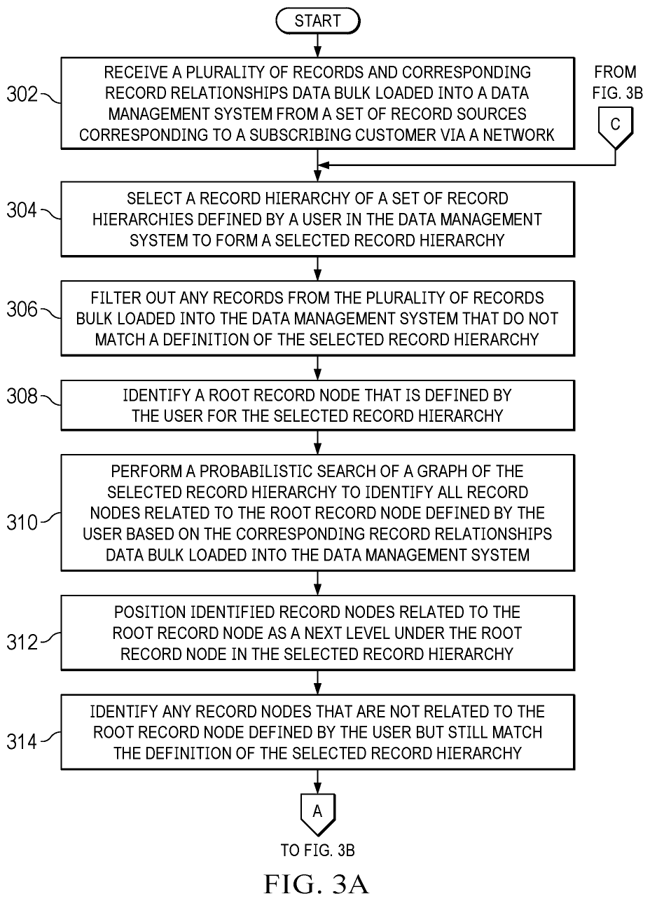

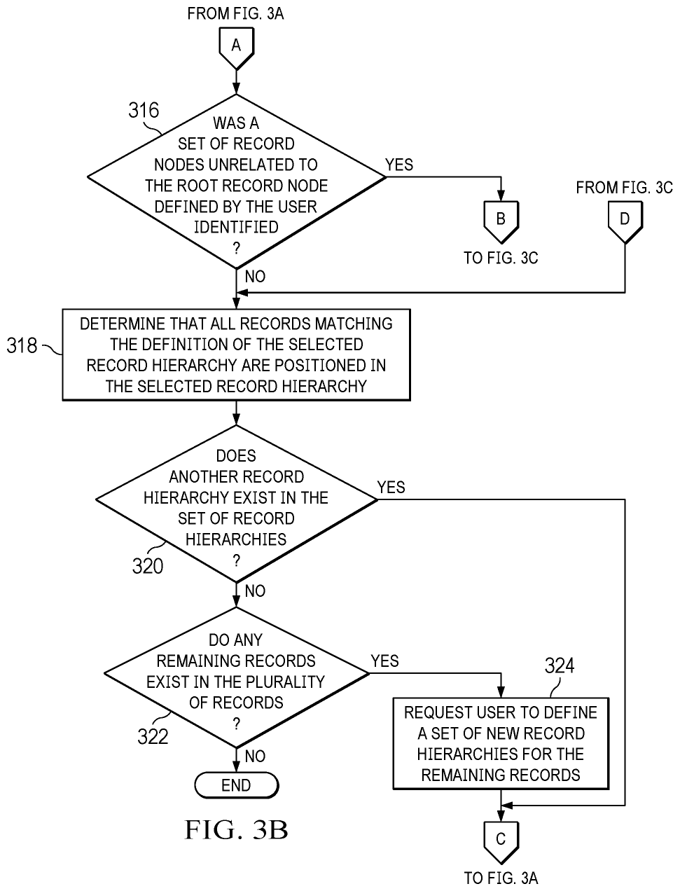

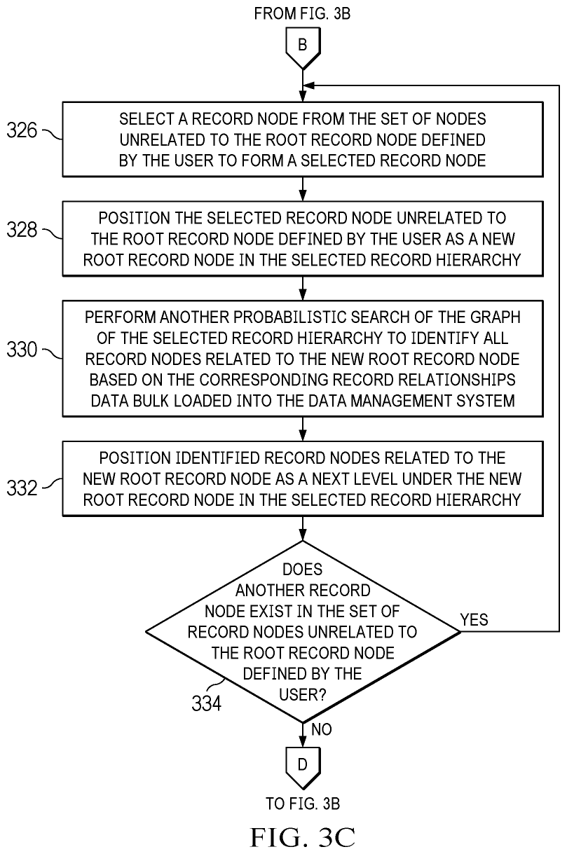

With reference now to FIGS. 3A-3C, a flowchart illustrating a process for placing records in record hierarchies defined in a data management system is shown in accordance with an illustrative embodiment. The process shown in FIGS. 3A-3C may be implemented in a computer, such as, for example, server 104 in FIG. 1 or data processing system 200 in FIG. 2. For example, the process shown in FIGS. 3A-3C may be implemented in data manager 218 in FIG. 2.

The process begins when the computer receives a plurality of records and corresponding record relationships data bulk loaded into the data management system from a set of record sources corresponding to a subscribing customer via a network (step 302). It should be noted that the computer includes the data management system. In response to receiving the plurality of records and corresponding record relationships data bulk loaded into the data management system, the computer selects a record hierarchy of a set of record hierarchies defined by a user in the data management system to form a selected record hierarchy (step 304). In addition, the computer filters out any records from the plurality of records bulk loaded into the data management system that do not match a definition of the selected record hierarchy (step 306). Further, the computer identifies a root record node that is defined by the user for the selected record hierarchy (step 308).

Afterward, the computer performs a probabilistic search of a graph of the selected record hierarchy to identify all record nodes related to the root record node defined by the user based on the corresponding record relationships data bulk loaded into the data management system (step 310). The computer positions identified record nodes related to the root record node as a next level under the root record node in the selected record hierarchy (step 312). The computer also identifies any record nodes that are not related to the root record node defined by the user but still match the definition of the selected record hierarchy (step 314).

The computer makes a determination as to whether a set of record nodes unrelated to the root record node defined by the user was identified (step 316). If the computer determines that a set of record nodes unrelated to the root record node defined by the user was not identified, no output of step 316, then the computer determines that all records matching the definition of the selected record hierarchy are positioned in the selected record hierarchy (step 318). Afterward, the computer makes a determination as to whether another record hierarchy exists in the set of record hierarchies (step 320).

If the computer determines that another record hierarchy does exist in the set of record hierarchies, yes output of step 320, then the process returns to step 304 where the computer selects another record hierarchy from the set of record hierarchies. If the computer determines that another record hierarchy does not exist in the set of record hierarchies, no output of step 320, then the computer makes a determination as to whether any remaining records exist in the plurality of records bulk loaded into the data management system (step 322). If the computer determines that remaining records do exist in the plurality of records bulk loaded into the data management system, yes output of step 322, then the computer sends a request to the user to define a set of new record hierarchies in the data management system for the remaining records (step 324). Thereafter, the process returns to step 304 where the computer selects a new record hierarchy in the set of new record hierarchies defined by the user. If the computer determines that no remaining records exist in the plurality of records bulk loaded into the data management system, no output of step 322, then the process terminates thereafter.

Returning again to step 316, if the computer determines that a set of record nodes unrelated to the root record node defined by the user was identified, yes output of step 316, then the computer selects a record node from the set of nodes unrelated to the root record node defined by the user to form a selected record node (step 326). The computer positions the selected record node unrelated to the root record node defined by the user as a new root record node in the selected record hierarchy (step 328). In addition, the computer performs another probabilistic search of the graph of the selected record hierarchy to identify all record nodes related to the new root record node based on the corresponding record relationships data bulk loaded into the data management system (step 330). The computer positions identified record nodes related to the new root record node as a next level under the new root record node in the selected record hierarchy (step 332).

Afterward, the computer makes a determination as to whether another record node exists in the set of record nodes unrelated to the root record node defined by the user (step 334). If the computer determines that another record node does exist in the set of record nodes unrelated to the root record node defined by the user, yes output of step 334, then the process returns to step 326 where the computer selects another record node from the set of record nodes unrelated to the root record node defined by the user. If the computer determines that another record node does not exist in the set of record nodes unrelated to the root record node defined by the user, no output of step 334, then the process returns to step 318 where the computer determines that all records matching the definition of the selected record hierarchy are positioned in the selected record hierarchy.

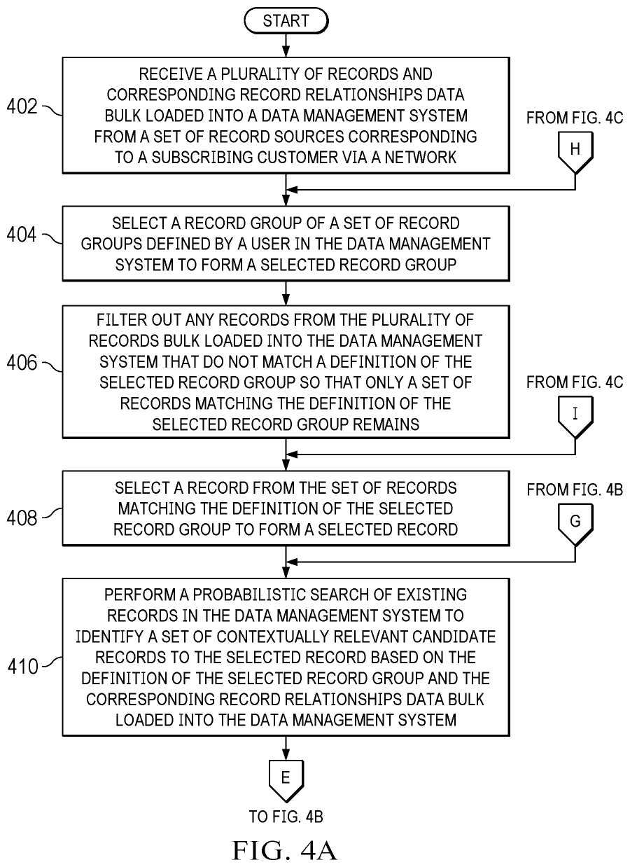

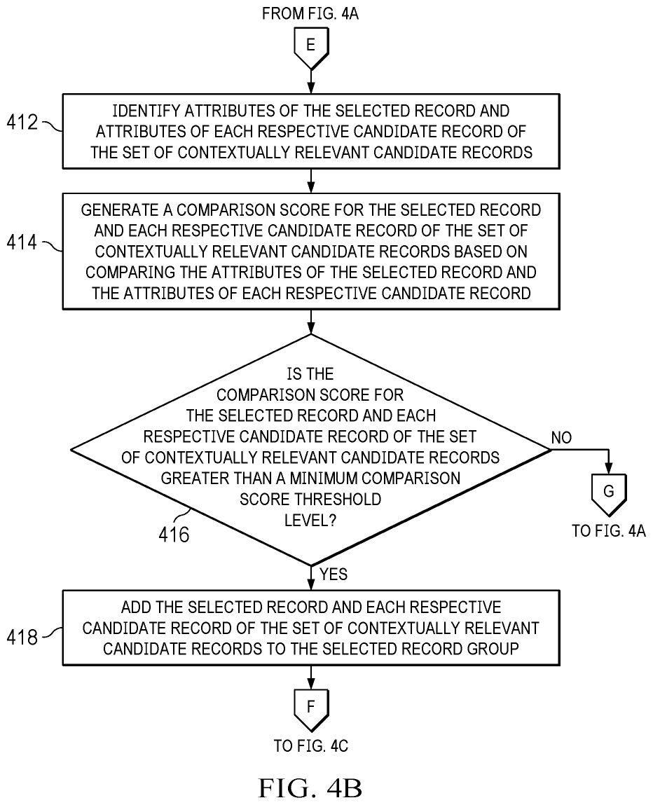

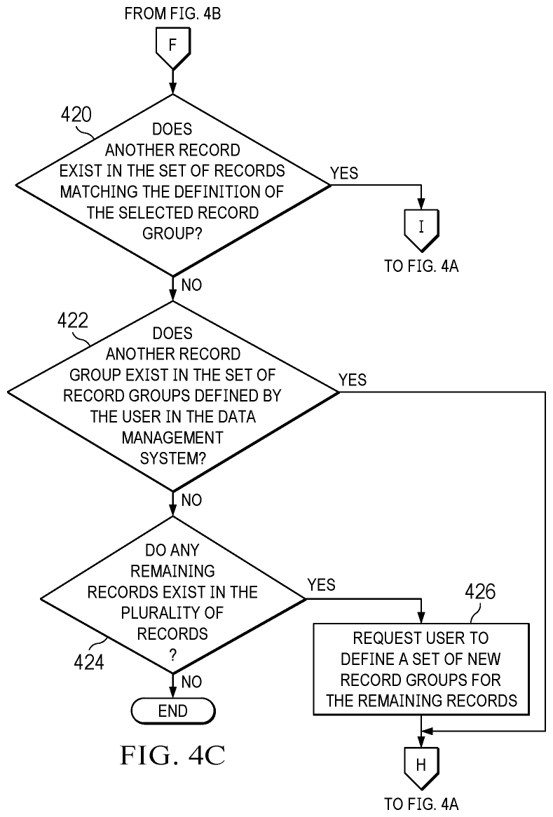

With reference now to FIGS. 4A-4C, a flowchart illustrating a process for grouping records in record groups defined in a data management system is shown in accordance with an illustrative embodiment. The process shown in FIGS. 4A-4C may be implemented in a computer, such as, for example, server 104 in FIG. 1 or data processing system 200 in FIG. 2. For example, the process shown in FIGS. 4A-4C may be implemented in data manager 218 in FIG. 2.

The process begins when the computer receives a plurality of records and corresponding record relationships data bulk loaded into a data management system from a set of record sources corresponding to a subscribing customer via a network (step 402). In response to receiving the plurality of records and corresponding record relationships data bulk loaded into the data management system, the computer selects a record group of a set of record groups defined by a user in the data management system to form a selected record group (step 404). In addition, the computer filters out any records from the plurality of records bulk loaded into the data management system that do not match a definition of the selected record group so that only a set of records matching the definition of the selected record group remains (step 406).

Afterward, the computer selects a record from the set of records matching the definition of the selected record group to form a selected record (step 408). Further, the computer performs a probabilistic search of existing records in the data management system to identify a set of contextually relevant candidate records to the selected record based on the definition of the selected record group and the corresponding record relationships data bulk loaded into the data management system (step 410). Furthermore, the computer identifies attributes of the selected record and attributes of each respective candidate record of the set of contextually relevant candidate records (step 412). Moreover, the computer generates a comparison score for the selected record and each respective candidate record of the set of contextually relevant candidate records based on comparing the attributes of the selected record and the attributes of each respective candidate record (step 414).

The computer makes a determination as to whether the comparison score for the selected record and each respective candidate record of the set of contextually relevant candidate records is greater than a minimum comparison score threshold level (step 416). If the computer determines that the comparison score for the selected record and each respective candidate record of the set of contextually relevant candidate records is less than the minimum comparison score threshold level, no output of step 416, then the process returns to step 410 where the computer performs another probabilistic search of existing records in the data management system to identify another set of contextually relevant candidate records to the selected record. If the computer determines that the comparison score for the selected record and each respective candidate record of the set of contextually relevant candidate records is greater than the minimum comparison score threshold level, yes output of step 416, then the computer adds the selected record and each respective candidate record of the set of contextually relevant candidate records to the selected record group (step 418).

Afterward, the computer makes a determination as to whether another record exists in the set of records matching the definition of the selected record group (step 420). If the computer determines that another record does exist in the set of records matching the definition of the selected record group, yes output of step 420, then the process returns to step 408 where the computer selects another record from the set of records matching the definition of the selected record group. If the computer determines that another record does not exist in the set of records matching the definition of the selected record group, no output of step 420, then the computer makes a determination as to whether another record group exists in the set of record groups defined by the user in the data management system (step 422).

If the computer determines that another record group does exist in the set of record groups defined by the user in the data management system, yes output of step 422, then the process returns to step 404 where the computer selects another record group from the set of record groups defined by the user in the data management system. If the computer determines that another record group does not exist in the set of record groups defined by the user in the data management system, no output of step 422, then the computer makes a determination as to whether any remaining records exist in the plurality of records bulk loaded into the data management system (step 424). If the computer determines that remaining records do exist in the plurality of records bulk loaded into the data management system, yes output of step 424, then the computer sends a request to the user to define a set of new record groups for the remaining records (step 426). Thereafter, the process returns to step 404 where the computer selects a new record group from the set of new record groups defined by the user. If the computer determines that no remaining records exist in the plurality of records bulk loaded into the data management system, no output of step 424, then the process terminates thereafter.

Thus, illustrative embodiments of the present invention provide a computer-implemented method, computer system, and computer program product for automatic management of record hierarchies and record groups defined in the data management system in real time. The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for managing record hierarchies and record groups in a data management system, the computer-implemented method comprising:
identifying, by a computer, a root record node that is defined by a user for a selected record hierarchy;
performing, by the computer, a probabilistic search of a graph of the selected record hierarchy to identify record nodes related to the root record node defined by the user based on record relationships data bulk loaded into the data management system;
positioning, by the computer, identified record nodes related to the root record node as a next level under the root record node in the selected record hierarchy;
identifying, by the computer, any record nodes that are not related to the root record node defined by the user but match a definition of the selected record hierarchy;
determining, by the computer, whether a set of record nodes unrelated to the root record node defined by the user was identified; and
responsive to the computer determining that a set of record nodes unrelated to the root record node defined by the user was not identified, determining, by the computer, that records matching the definition of the selected record hierarchy are positioned in the selected record hierarchy.

2. The computer-implemented method of claim 1 further comprising:
responsive to the computer determining that a set of record nodes unrelated to the root record node defined by the user was identified, selecting, by the computer, a record node from the set of nodes unrelated to the root record node defined by the user to form a selected record node;
positioning, by the computer, the selected record node unrelated to the root record node defined by the user as a new root record node in the selected record hierarchy;
performing, by the computer, another probabilistic search of the graph of the selected record hierarchy to identify record nodes related to the new root record node based on the record relationships data bulk loaded into the data management system; and
positioning, by the computer, identified record nodes related to the new root record node as a next level under the new root record node in the selected record hierarchy.

3. The computer-implemented method of claim 1 further comprising:
receiving, by the computer, a plurality of records and corresponding record relationships data bulk loaded into the data management system from a set of record sources via a network.

4. The computer-implemented method of claim 3 further comprising:
responsive to the computer receiving the plurality of records and the corresponding record relationships data bulk loaded into the data management system, selecting, by the computer, a record hierarchy of a set of record hierarchies defined by the user in the data management system to form the selected record hierarchy; and
filtering out, by the computer, any records from the plurality of records bulk loaded into the data management system that do not match the definition of the selected record hierarchy.

5. The computer-implemented method of claim 3 further comprising:
responsive to the computer receiving the plurality of records and the corresponding record relationships data bulk loaded into the data management system, selecting, by the computer, a record group of a set of record groups defined by the user in the data management system to form a selected record group; and
filtering out, by the computer, any records from the plurality of records bulk loaded into the data management system that do not match a definition of the selected record group so that a set of records matching the definition of the selected record group remains.

6. The computer-implemented method of claim 5 further comprising:
selecting, by the computer, a record from the set of records matching the definition of the selected record group to form a selected record;
performing, by the computer, a probabilistic search of existing records in the data management system to identify a set of contextually relevant candidate records to the selected record based on the definition of the selected record group and the corresponding record relationships data bulk loaded into the data management system;
identifying, by the computer, attributes of the selected record and attributes of each respective candidate record of the set of contextually relevant candidate records; and
generating, by the computer, a comparison score for the selected record and each respective candidate record of the set of contextually relevant candidate records based on comparing the attributes of the selected record and the attributes of each respective candidate record.

7. The computer-implemented method of claim 6 further comprising:
determining, by the computer, whether the comparison score for the selected record and each respective candidate record of the set of contextually relevant candidate records is greater than a minimum comparison score threshold level; and
responsive to the computer determining that the comparison score for the selected record and each respective candidate record of the set of contextually relevant candidate records is greater than the minimum comparison score threshold level, adding, by the computer, the selected record and each respective candidate record of the set of contextually relevant candidate records to the selected record group.

8. The computer-implemented method of claim 7 further comprising:
responsive to the computer determining that at least one of another record hierarchy or another record group does not exist in at least one of the set of record hierarchies or the set of record groups, determining, by the computer, whether any remaining records exist in the plurality of records bulk loaded into the data management system; and
responsive to the computer determining that remaining records do exist in the plurality of records bulk loaded into the data management system, sending, by the computer, a request to the user to define at least one of a set of new record hierarchies or a set of new record groups in the data management system for the remaining records.

9. A computer system for managing record hierarchies and record groups in a data management system, the computer system comprising:
a bus system;
a storage device connected to the bus system, wherein the storage device stores program instructions; and
a processor connected to the bus system, wherein the processor executes the program instructions to:
identify a root record node that is defined by a user for a selected record hierarchy;
perform a probabilistic search of a graph of the selected record hierarchy to identify record nodes related to the root record node defined by the user based on record relationships data bulk loaded into the data management system;
position identified record nodes related to the root record node as a next level under the root record node in the selected record hierarchy;
identify any record nodes that are not related to the root record node defined by the user but match a definition of the selected record hierarchy;
determine whether a set of record nodes unrelated to the root record node defined by the user was identified; and
determine that records matching the definition of the selected record hierarchy are positioned in the selected record hierarchy in response to determining that a set of record nodes unrelated to the root record node defined by the user was not identified.

10. The computer system of claim 9, wherein the processor further executes the program instructions to:
select a record node from the set of nodes unrelated to the root record node defined by the user to form a selected record node in response to determining that a set of record nodes unrelated to the root record node defined by the user was identified;
position the selected record node unrelated to the root record node defined by the user as a new root record node in the selected record hierarchy;
perform another probabilistic search of the graph of the selected record hierarchy to identify record nodes related to the new root record node based on the record relationships data bulk loaded into the data management system; and
position identified record nodes related to the new root record node as a next level under the new root record node in the selected record hierarchy.

11. The computer system of claim 9, wherein the processor further executes the program instructions to:
receive a plurality of records and corresponding record relationships data bulk loaded into the data management system from a set of record sources via a network.

12. The computer system of claim 11, wherein the processor further executes the program instructions to:
select a record hierarchy of a set of record hierarchies defined by the user in the data management system to form the selected record hierarchy in response to receiving the plurality of records and the corresponding record relationships data bulk loaded into the data management system; and
filter out any records from the plurality of records bulk loaded into the data management system that do not match the definition of the selected record hierarchy.

13. The computer system of claim 11, wherein the processor further executes the program instructions to:
select a record group of a set of record groups defined by the user in the data management system to form a selected record group in response to receiving the plurality of records and the corresponding record relationships data bulk loaded into the data management system; and
filter out any records from the plurality of records bulk loaded into the data management system that do not match a definition of the selected record group so that a set of records matching the definition of the selected record group remains.

14. A computer program product for managing record hierarchies and record groups in a data management system, the computer program product comprising a computer-readable storage medium having program instructions embodied therewith, the program instructions executable by a computer to cause the computer to perform a method of:
identifying, by the computer, a root record node that is defined by a user for a selected record hierarchy;
performing, by the computer, a probabilistic search of a graph of the selected record hierarchy to identify record nodes related to the root record node defined by the user based on record relationships data bulk loaded into the data management system;
positioning, by the computer, identified record nodes related to the root record node as a next level under the root record node in the selected record hierarchy;
identifying, by the computer, any record nodes that are not related to the root record node defined by the user but match a definition of the selected record hierarchy;
determining, by the computer, whether a set of record nodes unrelated to the root record node defined by the user was identified; and
responsive to the computer determining that a set of record nodes unrelated to the root record node defined by the user was not identified, determining, by the computer, that records matching the definition of the selected record hierarchy are positioned in the selected record hierarchy.

15. The computer program product of claim 14 further comprising:
responsive to the computer determining that a set of record nodes unrelated to the root record node defined by the user was identified, selecting, by the computer, a record node from the set of nodes unrelated to the root record node defined by the user to form a selected record node;
positioning, by the computer, the selected record node unrelated to the root record node defined by the user as a new root record node in the selected record hierarchy;
performing, by the computer, another probabilistic search of the graph of the selected record hierarchy to identify record nodes related to the new root record node based on the record relationships data bulk loaded into the data management system; and
positioning, by the computer, identified record nodes related to the new root record node as a next level under the new root record node in the selected record hierarchy.

16. The computer program product of claim 14 further comprising:
receiving, by the computer, a plurality of records and corresponding record relationships data bulk loaded into the data management system from a set of record sources via a network.

17. The computer program product of claim 16 further comprising:
responsive to the computer receiving the plurality of records and the corresponding record relationships data bulk loaded into the data management system, selecting, by the computer, a record hierarchy of a set of record hierarchies defined by the user in the data management system to form the selected record hierarchy; and
filtering out, by the computer, any records from the plurality of records bulk loaded into the data management system that do not match the definition of the selected record hierarchy.

18. The computer program product of claim 16 further comprising:
responsive to the computer receiving the plurality of records and the corresponding record relationships data bulk loaded into the data management system, selecting, by the computer, a record group of a set of record groups defined by the user in the data management system to form a selected record group; and
filtering out, by the computer, any records from the plurality of records bulk loaded into the data management system that do not match a definition of the selected record group so that a set of records matching the definition of the selected record group remains.

19. The computer program product of claim 18 further comprising:
selecting, by the computer, a record from the set of records matching the definition of the selected record group to form a selected record;
performing, by the computer, a probabilistic search of existing records in the data management system to identify a set of contextually relevant candidate records to the selected record based on the definition of the selected record group and the corresponding record relationships data bulk loaded into the data management system;
identifying, by the computer, attributes of the selected record and attributes of each respective candidate record of the set of contextually relevant candidate records; and
generating, by the computer, a comparison score for the selected record and each respective candidate record of the set of contextually relevant candidate records based on comparing the attributes of the selected record and the attributes of each respective candidate record.

20. The computer program product of claim 19 further comprising:
determining, by the computer, whether the comparison score for the selected record and each respective candidate record of the set of contextually relevant candidate records is greater than a minimum comparison score threshold level; and
responsive to the computer determining that the comparison score for the selected record and each respective candidate record of the set of contextually relevant candidate records is greater than the minimum comparison score threshold level, adding, by the computer, the selected record and each respective candidate record of the set of contextually relevant candidate records to the selected record group.
